(19) United States
(12) Patent Application Publication
(10) Pub. No.: US 2020/0251748 A1
(43) Pub. Date: Aug. 6, 2020

(54) FUEL CELL CATALYST

(71) Applicant: TOYOTA JIDOSHA KABUSHIKI KAISHA, Toyota-shi (JP)

(72) Inventor: Rui IMOTO, Yokohama-shi (JP)

(21) Appl. No.: 16/749,842

(22) Filed: Jan. 22, 2020

(30) Foreign Application Priority Data
Feb. 6, 2019 (JP) 2019-020114

(51) Int. Cl. H01M 4/90; H01M 8/1004

(52) U.S. Cl. CPC H01M 4/9083; H01M 8/1004

(57) ABSTRACT

The present invention provides a fuel cell catalyst that can demonstrate high activity during low loads and high loads.

A fuel cell catalyst comprising a carbon support having fine pores, and a catalyst metal supported by the carbon support, wherein
the carbon support has
   a mode diameter of mesopores in the range of 2.5 nm to 5.0 nm,
   a BET specific surface area in the range of 700 m²/g to 1300 m²/g,
   a median diameter of particle diameter in the range of 0.10 μm to 0.50 μm, and
   a crystallite size of (002) plane of carbon in the range of 5.0 nm to 12.0 nm.

### FIELD

This invention relates to a fuel cell catalyst.

### BACKGROUND

A fuel cell directly converts chemical energy into electrical energy by supplying fuel gas (hydrogen gas) and oxidant gas (oxygen gas) to two electrically connected electrodes to electrochemically cause oxidation of the fuel. The fuel cell is normally composed of a stack of single cells each having, as a basic structure, a membrane electrode assembly of an electrolyte membrane interposed between a pair of electrodes. In particular, solid polymer electrolyte fuel cells using a solid polymer electrolyte membrane as the electrolyte membrane have merits such as being easily miniaturized, and operating at low temperatures, such that they are given attention as power sources for portable or travel use.

In a solid polymer electrolyte fuel cell, a reaction of the following equation (1) proceeds at the anode (fuel electrode) where hydrogen is supplied:

H₂→2H⁺+2e⁻ (1)

The electrons (e⁻) generated in equation (1) above pass through the external circuit, and after performing work on an external load, arrive at the cathode (oxidizer electrode). Conversely, the protons (H⁺) generated in equation (1) above travel from the anode side to the cathode side of the solid polymer electrolyte membrane through electroosmosis while in a hydrated state in water.

At the cathode, a reaction of the following equation (2) proceeds:

2H⁺+½O₂+2e⁻→H₂O (2)

Therefore, in the overall cell, a reaction according to the following equation (3) proceeds, and an electromotive force is generated and electrical work is performed on an external load.

H₂+½O₂→H₂O (3)

Each electrode of the anode and the cathode generally has a laminated structure in the order of catalyst layer and gas dispersion layer from the electrolyte membrane side. The catalyst layer generally includes an electrode catalyst such as platinum or a platinum alloy for encouraging the electrode reactions above and an ionomer for the purpose of securing proton conductivity.

As the electrode catalyst, a catalyst metal supported by a conductive support such as a carbon support is generally used. Various materials have been examined as the support for improving the efficiency as a fuel cell.

For example, Patent Literature 1 discloses a fuel cell catalyst comprising a support having mesopores having a mode diameter of 1 to 10 nm before supporting the catalyst. Patent Literature 2 discloses a porous carbon having fine pores having a pore diameter of 10 nm, wherein the porous carbon is produced by mixing a carbon precursor with magnesium oxide, heat treating under nitrogen at 1000° C. for 1 hour, and eluting the magnesium oxide with sulfuric acid. Patent Literature 3 discloses a method for manufacturing a catalyst in which, after heat treating a carbon support to within 1700° C. to 2300° C., the catalyst particles are supported within the interior part of the support. Patent Literature 4 discloses a catalyst support comprising titanium compound-carbon composite particles in which carbon encapsulates a titanium compound, and having a chain structure with arrays of carbon particles.

### CITATION LIST

### Patent Literature

### [Patent Literature 1] Japanese Patent No. 5998277

### [Patent Literature 2] Japanese Unexamined Patent Publication (Kokai) No. 2015-057373

### [Patent Literature 3] Japanese Patent No. 6063039

### [Patent Literature 4] WO 2016/104587

### SUMMARY

### Technical Problem

However, there was still room for improvement in fuel cells using convention carbon supports as the support of an electrode catalyst in terms of achieving catalytic efficacy during both low load operation and high load operation.

The present invention was created out of consideration for the above circumstances, and has the object of providing a fuel cell catalyst that can exhibit high activity during low loads and high loads.

### Solution to Problem

The present invention achieves the above object through the following means.

<1> A fuel cell catalyst comprising a carbon support having fine pores, and a catalyst metal supported by the carbon support, wherein
the carbon support has

a mode diameter of mesopores in the range of 2.5 nm to 5.0 nm,

a BET specific surface area in the range of 700 m²/g to 1300 m²/g,

a median diameter of particle diameter in the range of 0.10 μm to 0.50 μm, and

a crystallite size of (002) plane of carbon in the range of 5.0 nm to 12.0 nm.

<2> The fuel cell catalyst according to <1> wherein the mode diameter of mesopores is in the range of 2.7 nm to 4.3 nm.
<3> The fuel cell catalyst according to <1> or <2>, wherein the BET specific surface area is in the range of 800 m²/g to 1200 m²/g.
<4> The fuel cell catalyst according to any one of <1> to <3>, wherein the median diameter is in the range of 0.15 μm to 0.40 μm.
<5> The fuel cell catalyst according to any one of <1> to <4>, wherein the crystallite size is in the range of 5.5 nm to 11.5 nm.
<6> A membrane electrode assembly comprising a cathode and an anode interposing an electrolyte membrane therebetween, wherein either of the cathode and the anode comprises the catalyst according to any one of <1> to <5>.
<7> A fuel cell comprising the membrane electrode assembly according to <6>.

### Advantageous Effects of Invention

According to the fuel cell catalyst of the present invention, by controlling a mesopore mode diameter, BET specific surface area, median diameter of particle diameter, and crystallite size of (002) plane of carbon in the carbon support to within predetermined ranges, the reduction of activity of the catalyst metal due to contact with the ionomer, i.e. ionomer poisoning, can be suppressed, and clogging due to generated water, i.e. flooding, can be suppressed, and high activity of the fuel cell can be demonstrated.

### BRIEF DESCRIPTION OF DRAWINGS

FIG. 1 is a schematic cross-section showing the configuration of the catalyst of the present invention covered with an ionomer.

FIG. 2 is a graph showing the results of measuring power generation performance during low loads for membrane electrode assemblies comprising the catalyst of the present invention.

FIG. 3 is a graph showing the results of measuring power generation performance during high loads for membrane electrode assemblies comprising the catalyst of the present invention.

### DESCRIPTION OF EMBODIMENTS

The embodiments of the present invention will be described in detail below. Further, the present invention is not limited to the embodiments below, but may be realized in various forms within the range thereof.

### <Fuel Cell Catalyst>

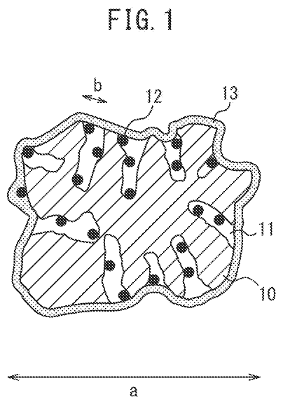

The fuel cell catalyst of the present invention comprises, as shown in FIG. 1, a carbon support 10 having fine pores 11 and a catalyst metal supported by the carbon support, wherein

the carbon support 10 has

a mode diameter (b) of mesopore in the range of 2.5 nm to 5.0 nm,

a BET specific surface area in the range of 700 m²/g to 1300 m²/g,

a median diameter (a) of particle diameter in the range of 0.10 μm to 0.50 μm,

and a crystallite size of (002) plane of carbon in the range of 5.0 nm to 12.0 nm.

A catalyst comprising a catalyst metal 12 supported by a carbon support 10 having fine pores 11 can support the catalyst metal 12 within the fine pores 11 of carbon support 10. Thus, the catalyst metal does not enter between the primary particles of the carbon support 10, and gas can easily disperse inside the support particle agglomerates. Therefore, the utilization rate of the catalyst metal is high. Accordingly, fuel cells comprising a catalyst layer containing this kind of catalyst demonstrate excellent power generation performance.

The catalyst layer generally contains a proton conducting compound called an ionomer 13 in addition to the carbon support 10 supporting the catalyst metal 12. The ionomer 13 acts as an adhesive between the electrolyte membrane and the catalyst layer, and as a conductor of protons generated in the catalyst layer.

The ionomer 13 penetrates into the fine pores 11 of the carbon support 10 supporting the catalyst metal 12 in the catalyst layer. Depending on the size of the fine pores, the ionomer penetrates into the fine pores excessively, whereby the activity of catalyst metal supported in the fine pores is reduced. In other words, an ionomer poisoning problem arises.

In the carbon support, there is the problem that generated water emerging from the electrode causes clogging, i.e. flooding, which decreases gas dispersion and thereby decreases the performance of the fuel cell.

In the carbon support supporting a catalyst metal of the present invention, by controlling a mesopore mode diameter, BET specific surface area, median diameter of particle diameter, and crystallite size of (002) plane of carbon to within predetermined ranges, the penetration of the ionomer into the mesopores is restricted whereby ionomer poisoning is suppressed, and surface characteristics suitable for easily discharging generated water are imparted whereby flooding can be suppressed. Thus, high activity of the fuel cell can be demonstrated.

### (Carbon Support)

The carbon support can be carbon particles such as carbon black or activated carbon, or a commercially available product, or can be manufactured according to a known manufacturing method.

In the present invention, the carbon support has a mesopore mode diameter (b) that is not less than 2.5 nm or not less than 2.7 nm, and not greater than 5.0 nm or not greater than 4.3 nm. Mesopore generally refers to a fine pore having a pore diameter of 2 to 50 nm in a carbon support, but the mesopores of the present invention have a mesopore mode diameter, which corresponds to the pore diameter most frequently found in the distribution of mesopore pore diameters, within the range above. By setting the mesopore mode diameter in this range, the penetration of the ionomer into the mesopores is suppressed, and a sufficient amount of catalyst metal can be supported. In the present invention, the carbon support may have fine pores which are not classified as mesopores.

In the present specification, the mesopore mode diameter is the value obtained as the most frequent pore diameter upon performing pore distribution analysis using the BJH method.

In the present invention, the BET specific surface area per g of the carbon support is not less than 700 m²/g, or not less than 800) m²/g, and not greater than 1300 m²/g, or not greater than 1200 m²/g. By setting the specific surface area in this range, a sufficient amount of fine pores can be formed, and a sufficient amount of catalyst metal can be supported.

In the present specification, the BET specific surface area is the value obtained by analyzing the adhesion isotherm obtained by performing a nitrogen gas adsorption-desorption measurement using a nitrogen gas adsorption method.

In the carbon support of the present invention, the particle size median diameter (D50), which is the diameter of the center value in the distribution of particle diameters, is not less than 0.10 μm, or not less than 0.15 μm, and not greater than 0.50 μm, or not greater than 0.40 μm. By setting the particle diameter in this range, a sufficient mechanical strength can be maintained even in the case of forming the aforementioned fine pores in the carbon support.

In the present specification, the particle diameter median diameter is the diameter at which the accumulated frequency is 50% based on the particle diameters of 100 particles measured by using a laser diffraction particle size distribution analyzer or observing particles using a scanning electron microscope (SEM).

Furthermore, in the carbon support of the present invention, the crystallite size of (002) plane of the carbon is not less than 5.0 nm or not less than 5.5 nm and not greater than 12.0 nm or not greater than 11.5 nm. By setting the crystallite size in this range, the extent of hydrophilization of fine pores in the carbon support can be restricted, whereby the penetration of the ionomer and flooding by generated water can be restricted.

In the present specification, the crystallite size is a value obtained by analysis using a powder X-ray diffraction method using CuKα rays, wherein a powdery electrode catalyst is analyzed by a powder X-ray diffraction method, and the half-value width β (radians) of the diffraction peak of each crystal plane is obtained from the resulting diffraction pattern. Then, the average value L (nm) of the crystallite size of the support is calculated according to the Scherrer formula: L=Kλ/β cos θ. Furthermore, in the formula, constant K (shape factor) is 0.89, λ is the wavelength (Å) of the X-ray, and θ is the diffraction angle.

Thus, the carbon support having physical property values can be manufactured, for example, as follows. First, temperate particles having particle diameters corresponding to the target fine pore distribution are mixed with a flowable material such as an imide resin, the mixture is baked in an inert atmosphere for carbonization. Thereafter, the template particles are dissolved in hydrofluoric acid or NaOH/EtOH, and removed, such that the desired fine pore distribution can be attained. The resulting carbon particles are heat-treated under an inert atmosphere. By this heat treatment, the carbon support is graphitized, the crystallites of the carbon material composing the carbon support grow large, such that the desired specific surface area and crystallite size can be achieved. The heating temperature is, for example, 1600 to 2100° C. The inert gas can be nitrogen or argon. Ultimately, the carbon support is ground to the target particle diameter by the dry grinding method combined together with the wet grinding method.

### (Catalyst Metal)

The catalyst metal is a metal having a function of performing catalytic action on electrochemical reactions in an anode and a cathode. The catalyst metal used in the anode catalyst layer may be any known catalyst metal that has catalytic action on oxidation reactions of hydrogen, and the catalyst metal used in the cathode catalyst layer may be any known catalyst metal that has catalytic action on reduction reactions of oxygen. Publicly known metals and alloys can be used.

Specifically, the catalyst metal can be at least one metal selected from the group consisting of platinum, palladium, ruthenium, gold, rhodium, iridium, osmium, iron, cobalt, nickel, chromium, zinc, and tantalum, or an alloy composed of any two or more thereof, and is preferably platinum or a platinum alloy.

The average particle diameter of the catalyst metal is, for example, not less than 2 nm, or not less than 3 nm, and not greater than 30 nm, or not greater than 10 nm. When the average particle diameter is at this level, catalyst activity is good, and endurance is improved. The average particle diameter of the catalyst particles is the value measured according to a method similar to that for particle diameter of the carbon support.

The amount of the supported catalyst metal can be 1 to 99 mass %, 10 to 90 mass %, or 30 to 70 mass % relative to the total catalyst.

### (Method for Manufacturing the Catalyst)

The catalyst metal is supported by the above carbon support according to a known method to obtain a catalyst. The supporting method can be an impregnation method, liquid phase reduction support method, evaporation dry method, colloidal adsorption method, spray pyrolysis method, or reverse micelle method.

### <Catalyst Layer>

The catalyst layer comprises the above catalyst and an ionomer. As shown in FIG. 1, in the catalyst layer of the present invention, the catalyst is covered with the ionomer 13, but this ionomer 13 has not penetrated into the mesopores 11 of the support 10. Therefore, the catalyst metal supported on the surface of support 10 is in contact with electrolyte 13, but the catalyst metal 12 supported on the interior of mesopore 11 is not in contact with the ionomer 13. The catalyst metal within the mesopores can form a three-phase boundary with the oxygen gas and water without contacting the ionomer, whereby a reaction activity area of the alloy microparticles can be secured.

### (Ionomer)

The ionomer is a polymer electrolyte having proton conductance, and is preferably a perfluoro-based proton exchange resin that is a fluoroalkyl copolymer having fluoroalkyl ether side chains and perfluoroalkyl side chains. Examples thereof include Nafion (trade name) by Dupont, Aciplex (trade name) by Asahi Kasei, Flemion (trade name) by Asahi Glass, and Gore-Select (trade name) by Japan Gore-Tex. The partial fluoropolymer can be a polymer of trifluoro styrene sulfonic acid or a substance with a sulfonic acid group introduced into polyvinylidene fluoride. Further, examples thereof include hydrocarbon proton exchange resins such as styrene-divinylbenzene copolymers and polyimide resins having sulfonic acid groups introduced therein.

The content of the ionomer in the catalyst layer can be appropriately set in accordance with the amount of carbon support, and the weight ratio of carbon support to ionomer can be a ratio of carbon support:ionomer of 1.0:0.5 to 1.0:1.2.

The catalyst layer can be a cathode catalyst layer or an anode catalyst layer, but it is preferable to use it as the cathode catalyst layer. This is because water is formed in the cathode catalyst layer, though the catalyst of the present invention can be effectively utilized by forming a three-phase boundary with water without contacting the electrolyte.

### (Method for Manufacturing the Catalyst Layer)

First, a catalyst ink comprising a catalyst comprising a catalyst metal supported on a carbon support, an ionomer, and a solvent is prepared. The solvent is not particularly limited, and can be a normal solvent used for forming a catalyst layer. Specifically, water, low alcohols with 1 to 4 carbon atoms such as cyclohexanol, methanol, ethanol, n-propanol, isopropanol, n-butanol, sec-butanol, isobutanol, and tert-butanol, propylene glycol, benzene, toluene, and xylene can be used. The solvents above can be used individually or in combinations as a mixed solution of two or more thereof.

The amount of solvent composing the catalyst ink is not particularly limited, as long as it can completely dissolve the ionomer. Specifically, the concentration of the solid portion of the catalyst and ionomer in the catalyst ink is preferably 1 to 50 wt % or 5 to 30 wt %.

Next, the catalyst ink is applied to the surface of the substrate. The method of applying it to the substrate is not particularly limited, and can be a known method. Specifically, the application can be performed using a spraying method, Gulliver printing method, die coater method, screen printing method, or a doctor blade method.

The substrate for applying the catalyst ink can be a solid polymer electrolyte membrane (electrolyte layer) or a gas diffusion substrate (gas diffusion layer). In this case, after forming the catalyst layer on the surface of the solid polymer electrolyte membrane (electrolyte layer) or the gas diffusion substrate (gas diffusion layer), the obtained laminate can be used directly for the manufacture of a membrane electrode assembly. Alternatively, a catalyst layer can be formed by using a peelable substrate such as a polytetrafluoroethylene (PTFE) sheet as the substrate, and after forming the catalyst layer on the substrate, peeling off the catalyst layer part and transferring it onto the solid polymer electrolyte membrane or the gas dispersion substrate.

Ultimately, the applied layer (membrane) of the catalyst ink is dried in an atmosphere of air or an atmosphere of inert gas at a temperature in the range of room temperature to 150° C. for 1 to 60 minutes. Thus, the catalyst layer is formed. The thickness (dry membrane thickness) of the catalyst layer is preferably 0.05 to 30 μm, or 1 to 20 μm.

### <Membrane Electrode Assembly>

According to the present invention, a fuel cell membrane electrode assembly comprising the above catalyst layer is provided. Essentially, a fuel cell membrane electrode assembly having a solid polymer electrolyte membrane, a cathode catalyst layer disposed on one side of the electrolyte membrane, an anode catalyst layer disposed on the other side of the electrolyte membrane, and a pair of gas diffusion layers interposing the electrolyte membrane, the anode catalyst layer and the cathode catalyst layer, is provided. In this membrane electrode assembly, at least one of the cathode catalyst layer and the anode catalyst layer is the above catalyst layer.

However, in consideration of the necessity for improving proton conductance and improving transport characteristics (gas diffusivity) of the reaction gases (in particular, O₂), it is preferable that at least the cathode catalyst layer be the above catalyst layer. The above catalyst layer can be used as the anode catalyst layer, can be used for both the cathode catalyst layer and the anode catalyst layer, and is not particularly limited.

### (Electrolyte Membrane)

The electrolyte membrane is, for example, composed of a solid polymer electrolyte. The solid polymer electrolyte has a function of selectively allowing protons generated at the anode catalyst layer during operation of the fuel cell to pass in the direction of the membrane thickness to the cathode catalyst layer. Additionally, the solid polymer electrolyte membrane has a function as a barrier preventing the mixing of fuel gas supplied on the anode side with the oxidant gas supplied on the cathode side.

The electrolyte material composing the solid polymer electrolyte membrane is not particularly limited, and can be a conventionally known material. For example, a fluorine-based polymer electrolyte or a hydrocarbon polymer electrolyte described previously as ionomers can be used. In this case, it is not necessary to use the same material as the polymer electrolyte used in the catalyst layer.

The thickness of the electrolyte layer can be appropriately determined in consideration of the characteristics of the fuel cell to be obtained, and is not particularly limited. The thickness of the electrolyte layer is normally in the range of 5 to 300 μm. By setting the thickness of the electrolyte layer in this range, the balance of strength during creation of the membrane or durability during use and output characteristics during use can be properly controlled.

### (Gas Dispersion Layer)

The gas dispersion layers (anode gas dispersion layer, cathode gas dispersion layer) have a function of promoting the dispersion of the gases (fuel gas or oxidant gas) supplied through the gas route of the separator to the catalyst layer, and a function as an electron conduction path.

The material composing the substrate of the gas dispersion layer is not particularly limited, and can be a conventionally known material. For example, it can be a sheet-like material having conductivity and porosity such as a carbon fabric, paper-like body, felt, or a non-woven fabric.

The thickness of the substrate can be appropriately determined in consideration of the characteristics of the gas dispersion layer to be obtained, and can be in the range of 30 to 500 μm. By setting the thickness of the substrate in this range, the balance of mechanical strength and dispersibility of gas and water can be properly controlled.

### (Method for Manufacturing the Membrane Electrode Assembly)

The method for manufacturing the membrane electrode assembly is not particularly limited, and can be a conventionally known method. For example, a method in which the catalyst layer is transferred or applied with a hot press to a solid polymer electrode membrane, and is then dried, and the gas dispersion layer is joined thereto; or a method in which two gas dispersion electrode (GDE) sheets are created by applying a catalyst layer on the microporous layer side (if there is no microporous layer, one surface of the substrate) of the gas dispersion layer and drying, and the gas dispersion electrodes are joined to both sides of the solid polymer electrolyte membrane by hot pressing can be used. The conditions of applying and joining, such as hot pressing, can be appropriately adjusted in accordance with the type of polymer electrolyte (perfluorosulfonic acid-based or hydrocarbon-based) inside the catalyst layer or the solid polymer electrolyte membrane.

### <Fuel Cell>

According to the present invention, a fuel cell having the above membrane electrode assembly is provided. Essentially, the present invention relates to a fuel cell having a pair of separators, an anode separator and a cathode separator, which interpose the above membrane electrode assembly.

### (Separator)

The separator has a function of electrically connecting cells in series when a plurality of single cells of a fuel cell are connected in series to compose a fuel cell stack. Additionally, the separator has a function as a barrier to mutually separate the fuel gas, oxidant gas and the coolant. In order to acquire routes thereof, as above, it is preferable that the separator be provided with gas routes and a coolant route. The material composing the separator can be a conventionally known material, for example, carbon such as dense carbon graphite or a carbon plate, or a metal such as stainless steel. The thickness and the size of the separator, and the shape and the size of each of the routes provided are not particularly limited and can be appropriately determined in consideration of the desired output characteristics of the fuel cell to be obtained.

The method for manufacturing the fuel cell is not particularly limited, and a method conventionally known in the field of fuel cells can be used.

### EXAMPLES

### Example 1

A polyamic acid resin (imide resin) as a carbon precursor, and magnesium oxide having an average crystallite size of 5 nm as template particles were mixed in a weight ratio of 90:10. Next, the mixture was heat treated for 1 hour at 1000° C. in an atmosphere of nitrogen, and by thermally decomposing the polyamic acid resin, a carbon powder was obtained. Ultimately, the obtained carbon powder was washed with sulfuric acid added at a rate of 1 mol/L to completely elute the magnesium oxide, and then dried to obtain a carbon support.

The obtained carbon support was heat treated at 1600° C. under normal pressure in an argon atmosphere to graphitize it.

The graphitized carbon support underwent dry grinding such that the particle median diameter of the particle size distribution by laser diffraction was 2 μm. Next, wet grinding was performed such that the particle median diameter of the particle size distribution by laser diffraction was 0.15 μm. The conditions for this wet grinding were as follows:
Device: LMZ015 (Ashizawa Finetech Ltd.)
Beads diameter: ϕ 0.1 mm
Peripheral speed: 14 m/s
Flow rate: 0.3 L/min
Operating time: 2 hours
Support weight: 12 g
Solvent mixing ratio: ethanol 1:purified water 1
Slurry concentration: 1 wt %

After wet grinding, the slurry was dried, and the dried material underwent dry grinding to grind the particles adhering to each other as flakes, and after heat treatment at 450° C., carbon support A was obtained.

Next, the carbon support A was dispersed in pure water, nitric acid was added thereto, and a predetermined amount of dinitrodiamine platinum salt aqueous solution was added thereto.

Thereafter, ethanol was added, and reduction was performed by heating. Thus, the platinum particles which constitute the catalyst metal were supported in the interior of the carbon support. The amount of supported platinum particles was 40 mass % relative to the catalyst supporting the platinum particles.

Next, the carbon support supporting the catalyst metal (catalyst) was added to ionomer (Nafion, Dupont) and solvent (water and alcohol), and mixed such at the weight ratio of ionomer to catalyst was 0.85:1 to create a catalyst ink. The obtained catalyst ink was applied to a substrate using an applicator, and then vacuum-dried to create an electrode sheet, on which the electrolyte membrane was transferred to create a fuel cell electrode.

### Example 2

Carbon support B and a fuel cell electrode were created in a manner similar to Example 1, except that the average crystallite size of magnesium oxide as the template particles was changed, heat treatment during graphitization was performed at 1700° C., and wet grinding was performed such that the particle median diameter of the particle size distribution by laser diffraction was 0.22 μm.

### Example 3

Carbon support C and a fuel cell electrode were created in a manner similar to Example 1, except that the average crystallite size of magnesium oxide as the template particles was changed, heat treatment during graphitization was performed at 1800° C., and wet grinding was performed such that the particle median diameter of the particle size distribution by laser diffraction was 0.31 μm.

### Example 4

Carbon support D and a fuel cell electrode were created in a manner similar to Example 1, except that the average crystallite size of magnesium oxide as the template particle was changed, heat treatment during graphitization was performed at 2100° C., and wet grinding was performed such that the particle median diameter of the particle size distribution by laser diffraction was 0.38 μm.

### Comparative Example 1

The fuel cell electrodes were created in a manner similar to Example 1, except that Denka Black (OSAB) by Denka Company Limited was used as the carbon support.

### Comparative Example 2

The fuel cell electrodes were created in a manner similar to Example 1, except that Ket Jen Black (EC300J) from Lion Specialty Chemical Co., Ltd. was used as the carbon support.

### Comparative Example 3

The carbon support and fuel cell electrodes were created in a manner similar to Example 1, except that the average crystallite size of magnesium oxide as the template particles was changed, heat treatment during graphitization was performed at 1800° C., heat treatment at 450° C. was performed without wet grinding.

Physical characteristics for the carbon support used in the Examples and Comparative Examples were measured according to the following methods.

### <Mesopore Mode Diameter and BET Specific Surface Area>

The adsorption isotherm for nitrogen gas on the carbon support was measured using an automated specific surface area/pore distribution analyzer (Tristar 3000, Shimadzu) in a fixed volume method. Analysis of the pore distribution was performed using the BJH method, and the mesopore mode diameter (nm) was determined from the most frequent pore diameter. Additionally, the BET specific surface area (m²/g) was determined from the amount of adsorbed nitrogen gas.

### <Particle Median Diameter>

Particle diameter for the carbon support in Examples 1 to 4 and Comparative Example 3 was measured using a laser diffraction particle size distribution analyzer (MT 3300, MicrotracBEL Corp.). The particle diameters for the carbon support in Comparative Examples 1 and 2 were small; therefore, 100 particle diameters were measured using a scanning electron microscope. The particle median diameter was determined based on the particle diameter (D50) at which the cumulative frequency was 50%.

### <Crystallite Size>

The powdered electrode catalyst was analyzed according to a powder X-ray diffraction method using a powder X-ray diffraction device RINT 2500 (Rigaku) which uses a CuKα radiation. Using the obtained diffraction pattern, the crystallite size Lc was determined from the diffraction peak on the incidence surface (002).

The results for the above measurements are shown in Table I below.

TABLE 1

| | Mesopore mode | BET specific | Particle median | Crystallite |
|---|---|---|---|---|
| | diameter | surface area | diameter | size |
| | (nm) | (m²/g) | (μm) | (nm) |
| Example 1 | 2.7 | 1292 | 0.15 | 5.5 |
| Example 2 | 3.0 | 1156 | 0.22 | 7.0 |
| Example 3 | 3.0 | 942 | 0.31 | 9.0 |
| Example 4 | 4.3 | 705 | 0.38 | 11.2 |
| Comparative | 2.8 | 818 | 0.01 | 1.1 |
| Example 1 | | | | |
| Comparative | 10 | 846 | 0.036 | 0.9 |
| Example 2 | | | | |
| Comparative | 10 | 670 | 1.8 | 1.5 |
| Example 3 | | | | |

The power generation characteristics (current and voltage characteristics) of fuel cells using the fuel cell electrodes of Examples 1 to 4 and Comparative Examples 1 to 3 were measured. Specifically, the fuel cells were energized under the following conditions and current density-voltage curves were obtained.
Anode gas: hydrogen gas with (dew point 77° C.) at relative humidity (RH) 90%
Cathode gas: air with (dew point 77° C.) at relative humidity (RH) 90%
Cell humidity (cooling water temperature): 80° C.

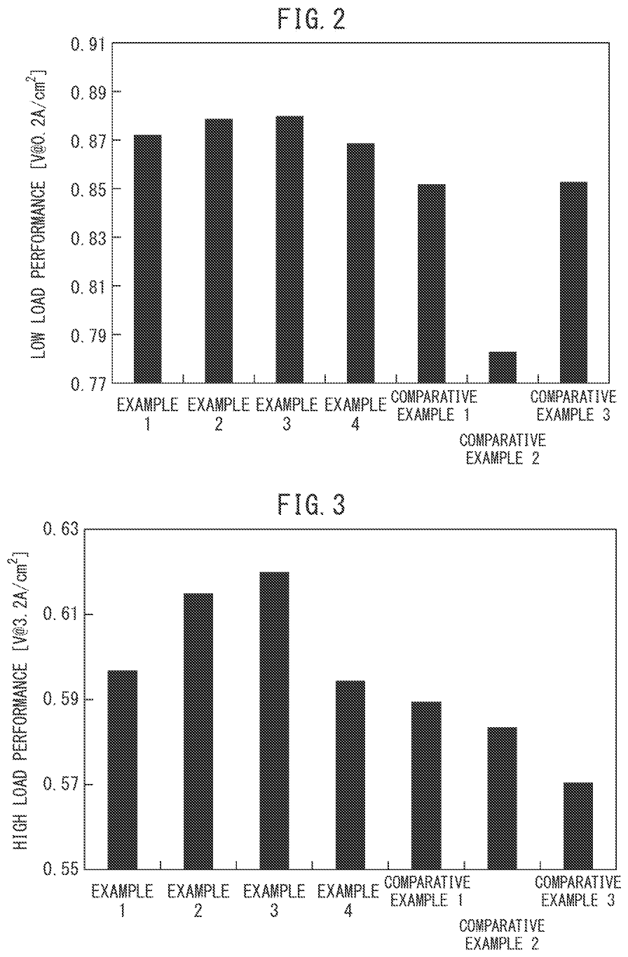

Based on the current density-voltage curve obtained in the power generation performance test under the above conditions of high humidification (RH 90%), the voltage (V) under low load (0.2 A/cm²⁾ and high load (3.5 A/cm²) in high humidification (RH 90%) for the fuel cells of Examples 1 to 4 and Comparative Examples 1 to 3. The results are shown in FIG. 2 and FIG. 3.

As shown in FIGS. 2 and 3, for both of the conditions low load (0.2 A/cm²) and high load (3.5 A/cm²), it can be understood that the fuel cell of the present invention which used a carbon support having predetermined characteristics had improved power generation performance of the fuel cell compared to the fuel cell which used a carbon support of the Comparative Example. In particular, Examples 1 to 4 suppressed flooding, improved the gas dispersibility in the interior due to small particle diameters, and demonstrated good high load performance.

### REFERENCE SIGNS LIST

10 Carbon support
11 Mesopore
12 Catalyst metal
13 Ionomer

What is claimed is:

1. A fuel cell catalyst comprising a carbon support having fine pores, and a catalyst metal supported by the carbon support, wherein
the carbon support has
a mode diameter of mesopores in the range of 2.5 nm to 5.0 nm,
a BET specific surface area in the range of 700 m²/g to 1300 m²/g,
a median diameter of particle diameter in the range of 0.10 μm to 0.50 μm, and
a crystallite size of (002) plane of carbon in the range of 5.0 nm to 12.0 nm.

2. The fuel cell catalyst according to claim 1 wherein the mode diameter of mesopores is in the range of 2.7 nm to 4.3 nm.

3. The fuel cell catalyst according to claim 1, wherein the BET specific surface area is in the range of 800 m²/g to 1200 m²/g.

4. The fuel cell catalyst according to claim 1, wherein the median diameter is in the range of 0.15 μm to 0.40 μm.

5. The fuel cell catalyst according to claim 1, wherein the crystallite size is in the range of 5.5 nm to 11.5 nm.

6. A membrane electrode assembly comprising a cathode and an anode interposing an electrolyte membrane therebetween, wherein either of the cathode and the anode comprises the catalyst according to claim 1.

7. A fuel cell comprising the membrane electrode assembly according to claim 6.
